(19) United States
(12) Patent Application Publication
(10) Pub. No.: US 2008/0225559 A1
(43) Pub. Date: Sep. 18, 2008

(54) SWITCHING-MODE POWER SUPPLY

(76) Inventor: Noboru Yanada, Osaka (JP)

Correspondence Address: BIRCH STEWART KOLASCH & BIRCH, PO BOX 747, FALLS CHURCH, VA, 22040-0747, US

(21) Appl. No.: 12/018,538

(22) Filed: Jan. 23, 2008

(30) Foreign Application Priority Data
Mar. 15, 2007 (JP) 2007-067525

(51) Int. Cl. H02M 1/12; H02H 7/125

(52) U.S. Cl. 363/44; 363/52

(57) ABSTRACT

A switching-mode power supply is configured so that two power supply lines are connected with each other via a series circuit consisting of a main switching element, a switch, and a transformer. The switching-mode power supply further includes a ripple voltage detecting circuit for detecting that a ripple voltage in one power supply line has a predetermined amount or more when a half short-circuit occurs in the main switching element. When the ripple voltage detecting circuit detects that the ripple voltage has a predetermined amount or more, the switch is opened so as to block supply of a current (supply of a voltage) to the main switching element. This allows the switching-mode power supply to avoid, with a simple circuit configuration and low costs, being an unstable state when the half short-circuit occurs in the main switching element.

This non-provisional application claims priority under 35 U.S.C. §119(a) on Patent Application No. 2007-67525 filed in Japan on Mar. 15, 2007, the entire contents of which are hereby incorporated by reference.

### FIELD OF THE INVENTION

The present invention relates to a switching-mode power supply, provided in an alternating current-direct current converter (AC-DC converter) or a direct current-direct current converter (DC-DC converter), for stabilizing and outputting a direct current voltage.

### BACKGROUND OF THE INVENTION

Switching-mode power supplies have been widely used as power supplies for electric apparatuses such as copying machines, printers, facsimiles, AV apparatuses, liquid crystal TVs, plasma display panels, and communication terminals. In general, switching-mode power supplies have a structure in which a commercial alternating current voltage is rectified and smoothed to be a direct current voltage, the direct current voltage is switched and converted into an alternating current electricity with high frequency, and the alternating current electricity is efficiently rectified to be a desired direct current voltage.

Such switching-mode power supplies require a technique for preventing the switching-mode power supplies themselves from being unstable when a half short-circuit occurs. The half short-circuit is a phenomenon in which a quite large current flows in a main switching element that performs the switching. An example of the half short-circuit is, in particular, a half short-circuit between the drain and the gate of the main switching element. An example of such technique is disclosed in Patent Document 1 (Japanese Unexamined Patent Publication No. 1989-282623 (Tokukaihei 1-282623; published on Nov. 14, 1989)), although this document relates to a direct current constant voltage power supply. With reference to FIG. 8, the following briefly explains an operation of the direct current constant voltage power supply disclosed in Patent Document 1.

The direct current constant voltage power supply illustrated in FIG. 8 includes: an input voltage source 201; a PNP transistor (switching element) 202; a coil 203; a diode 204; a capacitor 205; an output terminal 206 at a plus side and an output terminal 207 at a minus side; an error amplifier 208; a triangle-wave oscillator 209; a current limiting circuit 210; a bypath resistor 215; and an internal voltage source 216. The direct current constant voltage power supply in FIG. 8 further includes a voltage detecting circuit 220 that includes a zener diode 221 and resistors 222 and 223. The direct current constant voltage power supply further includes NPN transistors 224 and 225 as a protecting circuit.

In the direct current constant voltage power supply in FIG. 8, when the PNP transistor 202 is in an on-state, a voltage from the input voltage source 201 is transmitted via the PNP transistor 202 and the coil 203 and is output to the output terminal 206 as an output voltage Vout. At that time, a current is generated by the voltage from the input voltage source 201 being transmitted via the coil 203, and the capacitor 205 is charged by the current.

Further, when the PNP transistor 202 is in an off-state, the diode 204 serves as a flywheel diode. That is, at that time, the current stored in the capacitor 205 flows through the diode 204 and the coil 203, which generates a voltage. Because of this voltage, the output voltage Vout continuously arises at the output terminal 206.

By switching between the on-state and the off-state of the PNP transistor 202 according to variations in the output voltage Vout, it is possible to maintain the output voltage Vout at a predetermined level in the direct current constant voltage power supply in FIG. 8.

The switching between the on-state and the off-state of the PNP transistor 202 is performed as follows by the error amplifier 208 and the triangle-wave oscillator 209 provided as a control circuit.

The error amplifier 208 compares a triangle-wave voltage of the triangle-wave oscillator 209 with the output voltage Vout. When the triangle-wave voltage has a higher level than the output voltage Vout, the error amplifier 208 outputs a signal “L”, which makes the PNP transistor 202 be in the on-state. When the output voltage Vout has a higher level than the triangle-wave voltage, the error amplifier 208 outputs a signal “H”, which makes the PNP transistor 202 be in the off-state.

The current limiting circuit 210 detects a current between the output terminals 206 and 207 by use of a load resistor (not shown). When a current flowing in the load resistor has more than a predetermined current value (limitation current value), the current limiting circuit 210 outputs a stop signal to the triangle-wave oscillator 209. As a result, the triangle-wave oscillator 209 is kept in the off-state, and accordingly the PNP transistor 202 is kept in the off-state.

The voltage detecting circuit 220 is the series circuit that includes the zener diode 221 and the resistors 222 and 223 and is connected in parallel between the output terminals 206 and 207. The voltage detecting circuit 220 detects a value of the output voltage Vout. Further, the NPN transistors 224 and 225 form a so-called protecting circuit. When the voltage detecting circuit 220 detects a voltage that is less than a predetermined voltage, the protecting circuit causes the current limiting circuit 210 to output a stop signal.

The following explains operations of the voltage detecting circuit 220 and the protecting circuit in a case where a half short-circuit occurs in the direct current constant voltage power supply illustrated in FIG. 8 and in a case where the half short-circuit does not occur.

In the case where the half short-circuit does not occur and the current constant voltage power supply in FIG. 8 outputs a desired output voltage Vout, a voltage between the resistors 222 and 223 is larger than a saturation voltage between the base and the emitter of the NPN transistor 224, and accordingly the NPN transistor 224 is in the on-state. In this case, a current flows from the internal voltage source 216 to the NPN transistor 224. Consequently, a current is not supplied to the base of the NPN transistor 225 and the NPN transistor 225 is in the off-state. Accordingly, the current limiting circuit 210 operates in the same manner as in the case where the voltage detecting circuit 220 and the protecting circuit are not provided. That is, in this case, the on-state and the off-state of the PNP transistor 202 are controlled according to variations in the output voltage Vout, and thus the output voltage Vout is kept at a predetermined level. Further, in this case, by switching between the signals “L” and “H” of the triangle-wave oscillator 209, the on-state and the off-state of the PNP transistor 202 are controlled.

When the half short-circuit occurs, a current flowing in the load resistor increases, and accordingly the output voltage Vout drops. When the output voltage Vout drops, the voltage between the resistors 222 and 223 gets smaller than the saturation voltage between the base and emitter of the NPN transistor 224. Consequently, the NPN transistor 224 is in the off-state. In this case, a current is supplied from the internal voltage source 216 and the bypass resistor 215 to the base of the NPN transistor 225, and the NPN transistor 225 is in the on-state. When the NPN transistor 225 is in the on-state, the current limiting circuit 210 outputs a stop signal to the triangle-wave oscillator 209 and causes the triangle-wave oscillator 209 to be in the off-state. Consequently, the PNP transistor 202 is kept in the off-state.

With the above operation, the technique disclosed in Patent Document 1 prevents deterioration of the properties of the PNP transistor 202 that is a switching element or destruction of the PNP transistor 202 even when the half short-circuit continuously occurs.

However, the technique disclosed in Patent Document 1 has a problem that the technique cannot surely prevent the power supply from being in an unstable state.

When the half short-circuit occurs, the direct current constant voltage power supply in FIG. 8 stops the triangle-wave voltage of the triangle-wave oscillator 209, and thus causes the error amplifier 208 to output a signal for causing the PNP transistor 202 that is a switching element to be in the off-state, i.e. a stop signal. That is, even when the triangle-wave oscillator 209 stops, the error amplifier 208 operates.

Consequently, the PNP transistor 202 is not entirely disconnected from all electrical connections. Accordingly, there is a possibility that the half short-circuit occurs at the PNP transistor 202. When the half short-circuit occurs at the PNP transistor 202, the PNP transistor 202 is kept in the on-state and a current continues to flow in the PNP transistor 202 due to a voltage from the input voltage source 201.

Further, the direct current constant voltage power supply in FIG. 8 uses the internal voltage source 216 in order to control the NPN transistors 224 and 225. Accordingly, even if the PNP transistor 202 is kept in the off-state, a voltage from the internal voltage source 216 continues to be applied on the NPN transistor 225, and as a result a very large current flows in the NPN transistor 225.

As a result, with the technique disclosed in Patent Document 1, the direct current constant voltage power supply may result in an unstable state where the switching element and other components deteriorate or are destructed.

Here, it is assumed that a fuse is provided in the direct current constant voltage power supply in FIG. 8 in order to entirely disconnect the circuits. However, in addition to the two voltage sources as described above, the direct current constant voltage power supply in FIG. 8 further includes an internal voltage source (not shown) for substantially controlling the triangle-wave oscillator 209. Consequently, it is required that at least three fuses are provided in order to entirely disconnect the circuits. This results in complex circuit configuration and is disadvantageous in manufacture costs.

### SUMMARY OF THE INVENTION

The present invention was made in view of the foregoing problems. An object of the present invention is to provide a switching-mode power supply capable of preventing overheating due to a half short-circuit in a main switching element (main switching circuit) and of avoiding an unstable state, with a simple circuit configuration and with low costs.

In order to solve the foregoing problems, the switching-mode power supply of the present invention is a switching-mode power supply, including: a transformer with primary and secondary windings, for transmitting, as an alternating current voltage, a voltage applied on the primary winding to the secondary winding; a main switching circuit to be switched between a state where a voltage is applied on the primary winding and a state where the voltage is transmitted as an alternating current voltage to the secondary winding; and an output circuit for rectifying and smoothing the alternating current voltage so as to output a direct current voltage, the switching-mode power supply including: a detecting circuit for detecting a half short-circuit in the main switching circuit; and a current supply blocking switch circuit, connected in series with the main switching circuit, which is capable of being nonconductive so as to block supply of a current to the main switching circuit, the detecting circuit causing the current supply blocking switch circuit to be nonconductive when the detecting circuit detects a half short-circuit in the main switching circuit.

With the arrangement, the current supply blocking switch circuit is caused to be conductive at a time of normal operation (at a time when a half short-circuit does not occur in the main switching circuit). Consequently, the main switching circuit can be switched between a state where a voltage is applied on the primary winding and a state where the voltage is transmitted as an alternating current voltage to the secondary winding. On the other hand, when the detecting circuit detects the half short-circuit in the main switching circuit, the current supply blocking switch circuit is opened to be nonconductive. Thus, supply of a current to the main switching circuit is blocked.

Accordingly, with a simple circuit configuration and with low costs, it is possible to prevent overheating of the switching-mode power supply due to the half short-circuit in the main switching element and to avoid an unstable state of the switching-mode power supply.

In order to solve the foregoing problems, the switching-mode power supply of the present invention is a switching-mode power supply, including: an input section with first and second terminals, connected with a voltage source; an overcurrent blocking circuit connected in series with one of the first and second terminals in a stage after the input section; a transformer with primary and secondary windings, for transmitting, as an alternating current voltage, a voltage applied on the primary winding to the secondary winding; a main switching circuit to be switched between a state where a voltage is applied on the primary winding and a state where the voltage is transmitted as an alternating current voltage to the secondary winding; and an output circuit for rectifying and smoothing the alternating current voltage so as to output a direct current voltage, the switching-mode power supply including: a detecting circuit for detecting a half short-circuit in the main switching circuit; and a short-circuit switch circuit capable of being conductive so as to cause a short-circuit between two power supply lines connected with the primary winding, the detecting circuit causing the short-circuit switch circuit to be conductive when the detecting circuit detects a half short-circuit in the main switching circuit.

With the arrangement, the switching-mode power supply includes: the detecting circuit for detecting the half short-circuit occurring in the main switching circuit: and the short-circuit switch circuit. At a time of normal operation, the short-circuit switch circuit is caused to be nonconductive. Consequently, a current of not more than a predetermined amount (e.g. a current two times larger than a rated current) flows in the overcurrent blocking circuit. On the other hand, when the detecting circuit detects the half short-circuit occurring in the main switching circuit, the short-circuit switch circuit is closed to be conductive. Consequently, more current flows in the overcurrent blocking circuit, allowing the overcurrent blocking circuit to melt quickly. Thus, it is possible to promptly stop an operation of the switching-mode power supply of the present invention.

Therefore, with a simple circuit configuration and with low costs, it is possible to prevent overheating of the switching-mode power supply due to the half short-circuit in the main switching element and to avoid an unstable state of the switching-mode power supply.

In order to solve the foregoing problems, the switching-mode power supply of the present invention is a switching-mode power supply, including: an input section with first and second terminals, connected with a voltage source; an overcurrent blocking circuit connected in series with one of the first and second terminals in a stage after the input section; a filter circuit connected between a series circuit and the second terminal of the input section, the series circuit consisting of the first terminal of the input section and the overcurrent blocking circuit; a transformer with primary and secondary windings, for transmitting, as an alternating current voltage, a voltage applied on the primary winding to the secondary winding; a main switching circuit to be switched between a state where a voltage is applied on the primary winding and a state where the voltage is transmitted as an alternating current voltage to the secondary winding; and an output circuit for rectifying and smoothing the alternating current voltage so as to output a direct current voltage, the switching-mode power supply including: a detecting circuit for detecting a half short-circuit in the main switching circuit; and a filter short-circuit switch circuit, connected in parallel with the filter circuit, which is capable of being conductive so as to cause a short-circuit between two output terminals of the filter circuit, the detecting circuit causing the filter short-circuit switch circuit to be conductive when the detecting circuit detects a half short-circuit in the main switching circuit.

With the arrangement, the filter short-circuit switch circuit is caused to be nonconductive at a time of normal operation. Consequently, a current of not more than a predetermined amount (e.g. a current two times larger than a rated current) flows in the overcurrent blocking circuit. On the other hand, when the detecting circuit detects the half short-circuit occurring in the main switching circuit, the filter short-circuit switch circuit is closed to be conductive. At that time, a short-circuit occurs between output terminals of the filter circuit. That is, a very large current flows between the first and second terminals of the input section. Consequently, a current of not less than a predetermined amount instantly flows in the overcurrent blocking circuit. This allows the overcurrent blocking circuit to melt quickly, and allows an operation of the switching-mode power supply of the present invention to stop promptly.

Therefore, with a simple circuit configuration and with low costs, it is possible to prevent overheating of the switching-mode power supply due to the half short-circuit in the main switching element and to avoid an unstable state of the switching-mode power supply.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a circuit diagram of an embodiment of the present invention, illustrating a configuration example of a switching-mode power supply of the present invention.

FIG. 2 is a circuit diagram of another embodiment of the present invention, illustrating a configuration example of a switching-mode power supply of the present invention.

FIG. 3 is a circuit diagram of another embodiment of the present invention, illustrating a configuration example of a switching-mode power supply of the present invention.

FIG. 4 is a circuit diagram of another embodiment of the present invention, illustrating a configuration example of a switching-mode power supply of the present invention.

FIG. 5 is a circuit diagram of another embodiment of the present invention, illustrating a configuration example of a switching-mode power supply of the present invention.

FIG. 6 is a circuit diagram of another embodiment of the present invention, illustrating a configuration example of a switching-mode power supply of the present invention.

FIG. 7 is a circuit diagram illustrating a configuration of a conventional switching-mode power supply.

FIG. 8 is a circuit diagram illustrating a configuration of a conventional power supply.

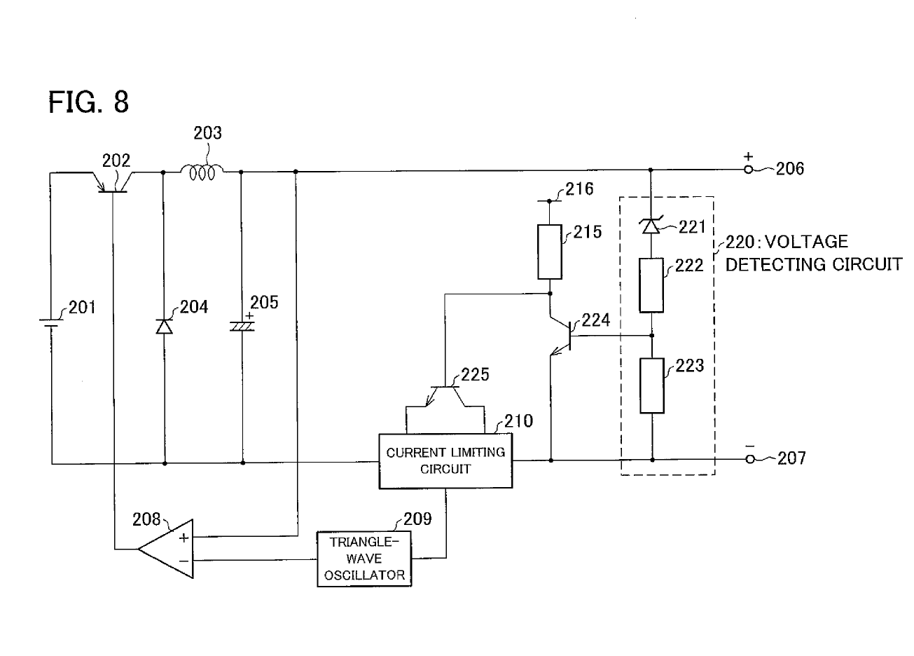

FIG. 9 is a graph indicative of a relationship between a current that flows in a fuse provided in the switching-mode power supply of the embodiment of the present invention and a time required to melt the fuse.

### DESCRIPTION OF THE EMBODIMENTS

A representative configuration of a conventional switching-mode power supply is as follows: the switching-mode power supply includes a main switching element for switching a direct current voltage applied on a primary side of a transformer. A control circuit controls a switching pulse width of the main switching element in accordance with an output voltage at a secondary side of the transformer. Consequently, the switching-mode power supply obtains a desired output voltage at a secondary side.

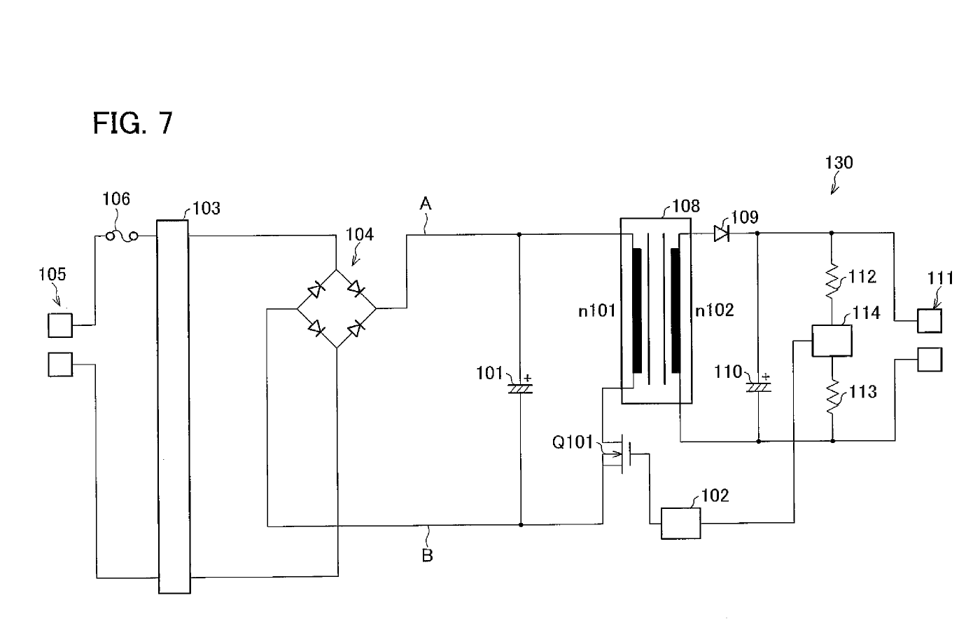

FIG. 7 is a circuit diagram illustrating a configuration of a switching-mode power supply 130 that is a conventional and general switching-mode power supply. As illustrated in FIG. 7, the switching-mode power supply 130 includes commercial power supply input terminals 105, a fuse 106, a filter circuit 103, a diode bridge 104, an input smoothing capacitor 101, a transformer 108 including a primary winding n101 and a secondary winding n102, a main switching element Q101, a diode 109, an output smoothing capacitor 110, dividing resistors 112 and 113, a comparison circuit 114, a control circuit 102, and output terminals 111.

An alternating current voltage is input to the commercial power supply input terminals 105, a noise component is removed from the alternating current voltage by the filter circuit 103, and the alternating current voltage is subjected to bridge-rectification by the diode bridge 104, and is smoothed by the input smoothing capacitor 101. The voltage smoothed by the input smoothing capacitor 101 is applied, as a smoothed voltage, across a power supply line A at a high level side and a power supply line B at a low level side.

The power supply lines A and B are connected with a series circuit consisting of the primary winding n101 of the transformer 108 and the main switching element Q101. The main switching element Q101 is switched between on and off by the control circuit 102. When the main switching element Q101 is in an on-state, the smoothed voltage is applied on the primary winding n101 of the transformer 108. When the smoothed voltage is applied on the primary winding n101 of the transformer 108, energy (excitation energy) is accumulated in the primary winding n101 of the transformer 108. Thereafter, when the main switching element Q101 is in an off-state, the energy is transmitted as an alternating current voltage to the secondary winding n102 of the transformer 108.

The alternating current voltage transmitted to the secondary winding n102 is subjected to half-wave rectification by the diode 109 and smoothed by the output smoothing capacitor 110, and then is output as a direct current voltage from the output terminals 111.

Further, the voltage to be output from the output terminals 111 is divided by the dividing resistors 112 and 113, and the divided voltage is input to the comparison circuit 114. The comparison circuit 114 compares the divided output voltage and a reference voltage, and outputs the result of the comparison to the control circuit 102.

Based on the result of the comparison supplied from the comparison circuit 114, the control circuit 102 controls switching cycle of the main switching element Q101 so that the switching-mode power supply 130 outputs a predetermined voltage.

Further, in the switching-mode power supply 130, the fuse 106 serving as means for preventing an overcurrent is provided between one of the input terminals 105 and the filter circuit 103. If a current with a predetermined amount or more flows, the fuse 106 is melted and disconnects the switching-mode power supply 130 from the commercial power source.

Various safety standards are provided for electronic apparatuses. The standards include the IEC standard (global safety standard), the UL standard (U.S.A.), the CSA standard (Canada), and the BS standard (Great Britain). In Japan, Electrical Appliance And Material Safety Law has been enforced since Apr. 1, 2001.

For example, Electrical Appliance And Material Safety Law establishes that authentication for safety standards requires a short-circuit experiment to confirm whether an unstable state such as fuming or firing occurs when both ends or both terminals of a component is short-circuited and when one terminal of a component is opened in consideration of a phenomenon that may occur in an electronic apparatus, such as attachment of foreign matters, misarrangement of wiring, and insufficient soldering.

However, in the case of the conventional switching-mode power supply, even if it satisfies the safety standards in manufacturing and shipping an electronic apparatus, when the main switching element Q101 deteriorates, there is a possibility that a half short-circuit occurs in the main switching element Q101. In the conventional switching-mode power supply, when the half short-circuit occurs in the main switching element Q101, problems arise before the fuse 106 is melted, such as: overheating of the filter circuit 103 and/or the diode bridge 104; deterioration of the properties of the main switching element Q101; and breakage of the main switching element Q101.

That is, even if the switching-mode power supply 130 satisfies requirements defined by the safety standards at a time of manufacturing and shipping an electronic apparatus, usage of the switching-mode power supply 130 over the years or usage of the switching-mode power supply 130 under inappropriate conditions may deteriorate the main switching element Q101 and insulating resistance may drop. When the half short-circuit occurs in the main switching element Q101, there is a time lag between a time when the half short-circuit occurs and a time when the fuse 106 is melted. Consequently, in the switching-mode power supply 130, an overcurrent flows in the filter circuit 103 and the diode bridge 104 before the fuse 106 is melted, which results in overheating. Further, the overheating may cause the main switching element Q101, the filter circuit 103, the diode bridge 104 etc. to emit fume or take fire. That is, the switching-mode power supply 130 may get in an unstable state.

It may be deemed that a switching-mode power supply of the present invention was made in view of the problems in the conventional switching-mode power supply 130.

The following explains embodiments of the present invention. For convenience of explanation, members having the same functions as the members that have been already explained with reference to the drawings are given the same reference signs and explanations thereof will be omitted here.

### Embodiment 1

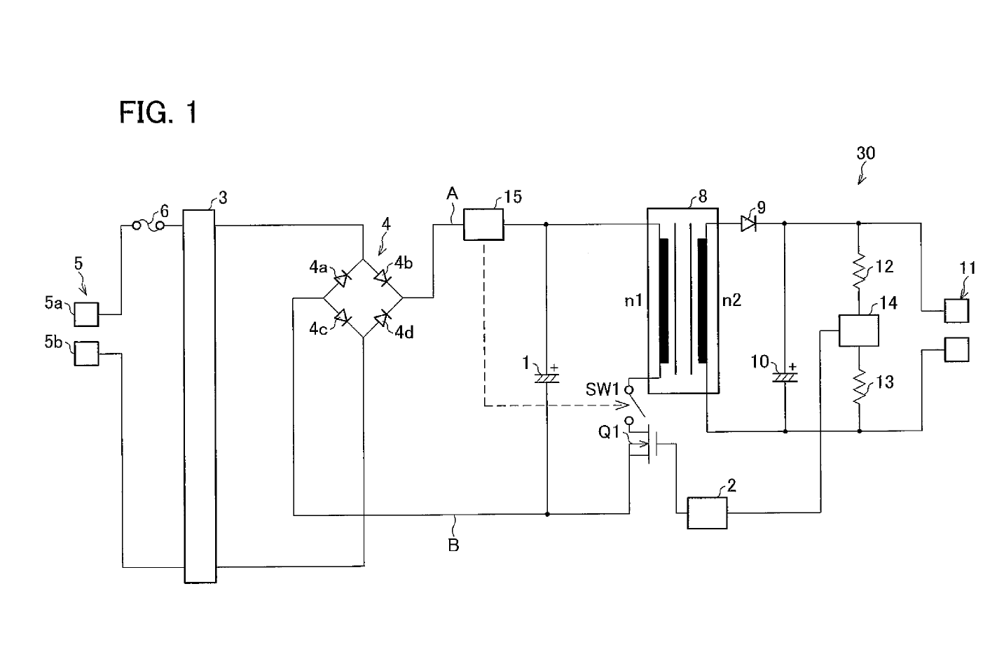

The following explains a switching-mode power supply of an embodiment of the present invention with reference to FIG. 1.

A switching-mode power supply 30 illustrated in FIG. 1 includes: a commercial power supply input terminal (input section) 5; a fuse (overcurrent blocking means) 6; a filter circuit 3; a diode bridge (rectifying means) 4; an input smoothing capacitor 1; a transformer 8 including a primary winding n1 and a secondary winding n2; a main switching element (main switching means) Q1; a diode (output means) 9; an output smoothing capacitor (output means) 10; dividing resistors 12 and 13; a comparison circuit 14; a control circuit 2; and output terminals (output means) 11. Further, a switch SW1 (current supply blocking switch means) is provided between the primary winding n1 of the transformer 8 and the main switching element Q1. A series circuit consisting of the primary winding n1 of the transformer 8, the switch SW1, and the main switching element Q1 is connected with power supply lines A and B. Further, in the switching-mode power supply 30 in FIG. 1, a ripple voltage detecting circuit (detecting means) 15 is connected in series with the power supply line A at a high level side.

The commercial power supply input terminal 5 includes two input terminals 5a and 5b to which a voltage (e.g. alternating current (AC) voltage 100V) is input from a commercial power supply (not shown). The voltage from the commercial power supply is input to the two input terminals with an error being 5V or less (i.e. the voltage ranging from 95V to 105V).

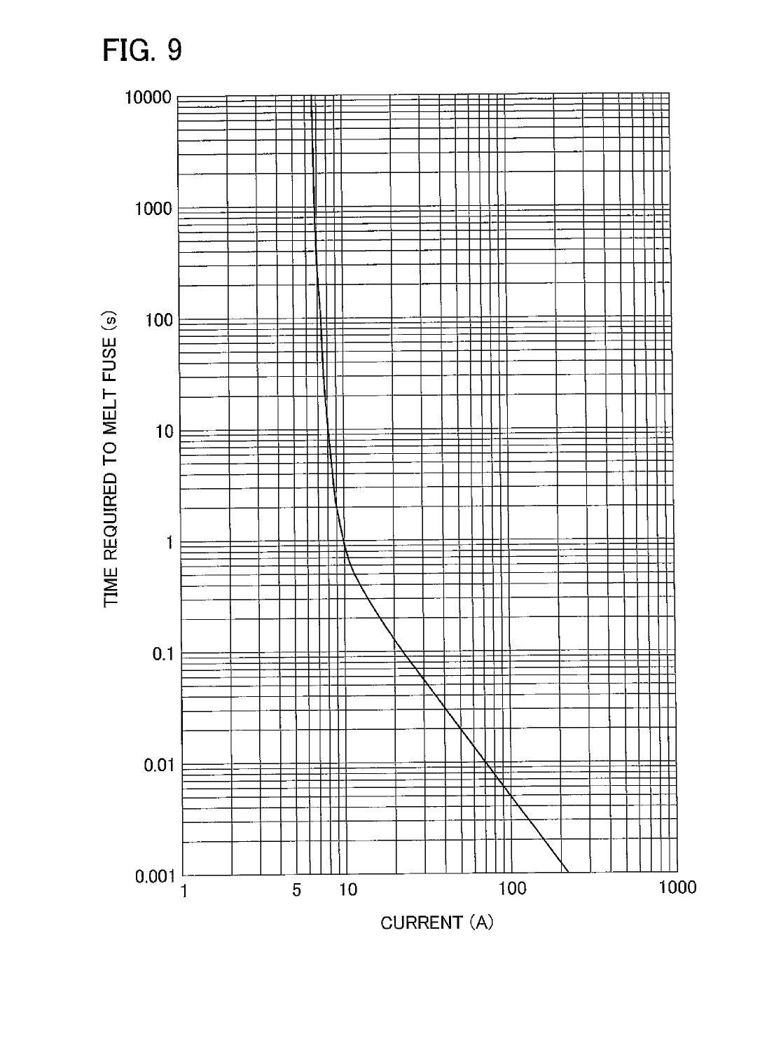

The fuse 6 is connected in series between the first terminal 5a of the commercial power supply input terminal 5 and one input terminal of the filter circuit 3. When a current with a predetermined amount or more (e.g. a current two times larger than a rated current) flows in the fuse 6, the fuse 6 is melted and the circuit is disconnected. In the present embodiment and later-mentioned embodiments, a fuse with a rated current of SA (manufactured by Littlelfuse, model number 237005) is used as the fuse 6. FIG. 9 is a graph showing a relationship between a current flowing in the fuse 6 and a time required to melt the fuse 6. As illustrated in the graph of FIG. 9, the fuse 6 is not melted for more than 10000 seconds when the rated current of 5A flows, whereas the fuse 6 is melted at approximately 1 second when 10A that is twice of the rated current flows.

One input terminal of the filter circuit 3 is connected with a series circuit consisting of the first terminal 5a of the commercial power supply input terminal 5 and the fuse 6, and the other input terminal of the filter circuit 3 is connected with the second terminal 5b of the commercial power supply input terminal 5. The filter circuit 3 removes noise components from an input alternating current voltage. Further, the filter circuit 3 prevents high frequency noises and a surge voltage from directly entering into the switching-mode power supply 30. The high frequency noises are generated due to flowback of a current generated by switching toward the commercial power supply, and the surge voltage is induced by thunderbolt etc.

The diode bridge 4 is a bridge circuit that is a combination of four diodes 4a to 4d. The cathode of the diode 4a and the anode of the diode 4b are commonly connected with one output terminal of the filter circuit 3. The cathode of the diode 4c and the anode of the diode 4d are commonly connected with the other output terminal of the filter circuit 3. The anodes of the diode 4a and the diode 4c are commonly connected with the power supply line B at the low level side. The cathodes of the diode 4b and the diode 4d are commonly connected with the power supply line A at the high level side. The alternating current voltage from the filter circuit 3 is subjected to bride rectification by the diode bridge 4, and is output across the power supply line B at the low level side and the power supply line A at the high level side.

The input smoothing capacitor 1 is connected in parallel between the power supply line A at the high level side and the power supply line B at the low level side so that the input smoothing capacitor 1 is positioned in a stage after the diode bridge 4 and in a stage before the transformer 8 and the main switching element Q1. Although the rectified alternating current voltage (pulsating current voltage) is a direct current voltage, it has level differences from 0V to the maximum value of the input voltage (approximately 1.4 times larger than a voltage of the commercial power supply), and accordingly cannot be used as a stable direct current voltage. For that reason, at a high-level portion of the pulsating current voltage, the input smoothing capacitor 1 is charged by a current generated from a part of the voltage, whereas at a low-level portion of the pulsating current voltage, the input smoothing capacitor 1 discharges the accumulated electric charge, so that the level differences in the pulsating current voltage arc cancelled. Thus, the input smoothing capacitor 1 smoothes the pulsating current voltage from the diode bridge 4 and outputs a direct current voltage including an alternating current ripple component.

The ripple voltage detecting circuit 15 detects a ripple voltage (alternating current ripple component in a direct current voltage output) that is a variation width of a voltage smoothed by the input smoothing capacitor 1 (smoothed voltage), the ripple voltage being generated in the power supply line A at the high level side, and the ripple voltage detecting circuit 15 controls opening/closing of the switch SW1 according to the result of the detection. As described above, the ripple voltage detecting circuit 15 is connected in series with the power supply line A at the high level side. Specifically, the ripple voltage detecting circuit 15 is connected in series between (i) a connecting point between the series circuit consisting of the primary winding n1 of the transformer 8, the switch SW1, and the main switching element Q1 and the input smoothing capacitor 1 and (ii) the diode bridge 4. The ripple voltage detecting circuit 15 may detect the ripple voltage by detecting a peak-peak value (a difference between the upper limit peak value and the lower limit peak value) of the smoothed voltage. However, detection of the ripple voltage is not limited to this. As the ripple voltage detecting circuit can be made based on a well-known technique, detailed explanation of the ripple voltage detecting circuit is omitted here.

Further, the ripple voltage detecting circuit 15 may control opening/closing of the switch SW1 in any method. An example of the method is using a logic signal, which is as follows: a reference value is predetermined for the ripple voltage detecting circuit 15. When the ripple voltage is higher than the predetermined reference value, the ripple voltage detecting circuit 15 outputs a High level signal. When the ripple voltage is lower than the predetermined reference voltage, the ripple voltage detecting circuit 15 outputs a Low level signal. Specific value of the predetermined reference value is different according to products etc. including the switching-mode power supply of the present invention. Therefore, the predetermined reference value may be suitably determined in consideration of the size of the ripple voltage at which the fuse 6 is to be melted and the circuit is to be disconnected.

The transformer 8 is a high frequency transformer including two windings that are the primary winding n1 and the secondary winding n2. An end of the secondary winding n2 of the transformer 8 is connected with the anode of the diode 9 and the cathode of the diode 9 is connected with the other of the secondary winding n2 via the output smoothing capacitor 10. Further, the cathode of the diode 9 is connected with the other end of the secondary winding n2 via the series circuit consisting of the dividing resistor 12, the comparison circuit 14, and the dividing resistor 13, and is connected with a terminal that is one of the output terminals 11. The other end of the second winding n2 is connected with a terminal that is the other of the output terminals 11.

The switch SW1 is a switch element that switches between on and off in response to a signal from the ripple voltage detecting circuit 15. The switch SW1 may be any well-known switch as long as it can switch between on and off in response to the signal from the ripple voltage detecting circuit 15. That is, in the case of using the binary control signals such as a High level signal and a Low level signal as described above, the switch SW1 may be any well-known switch as long as it is closed in response to the Low level signal and opened in response to the High level signal.

The main switching element Q1 is switched on/off by the control circuit 2. When the main switching element Q1 is in the on-state, the smoothed voltage is applied on the primary winding n1 of the transformer 8. When the smoothed voltage is applied on the primary winding n1 of the transformer 8, energy (excitation energy) is accumulated in the primary winding n1 of the transformer 8. Thereafter, when the main switching element Q1 is in the off-state, the energy is transmitted as an alternating current voltage to the secondary winding n2 of the transformer 8. In the present embodiment, N-channel Field Effect Transistor (FET) is used as the main switching element Q1. However, the main switching element Q1 is not limited to this as long as it has a switching function. For example, the main switching element Q1 may be a P-channel FET or may be other switching element such as a bipolar transistor.

The dividing resistors 12 and 13 divide the voltage to be output from the output terminals 11 and supply the divided voltage to the comparison circuit 14.

The comparison circuit 14 is connected with the control circuit 2. The comparison circuit 14 compares a divided output voltage with the reference voltage, and outputs the result of the comparison to the control circuit 2.

The control circuit 2 is connected with the gate of the main switching element Q1. The control circuit 2 controls switching of the main switching element Q1 based on the result of the comparison supplied from the comparison circuit 14. The control circuit 2 controls switching of the main switching element Q1 by generating a driving signal (gate voltage) for the main switching element Q1 and supplying the driving signal to the gate of the main switching element Q1 so that the switching-mode power supply 30 outputs a predetermined voltage. Feedback control by the control circuit 2 allows the switching-mode power supply 30 to output a stable direct current voltage.

The switching-mode power supply 30 in the present embodiment is based on a so-called separate excitation method. That is, the control circuit 2 controls switching based on PWM (Pulse Width Modulation) method. In general, examples of a method for controlling switching cycle of a main switching element in a switching-mode power supply include: (i) a separate excitation method in which, as in the present embodiment, an oscillator (i.e. the control circuit 2) is separately provided and the oscillator oscillates to control switching cycle; and (ii) a self-excitation method in which a main switching clement itself oscillates to control switching cycle. The control of switching in the switching-mode power supply in the present invention is applicable not only to a switching-mode power supply based on the separate excitation method but also to a switching-mode power supply based on the self-excitation method. In the case of using the switching-mode power supply based on the self-excitation method, the control circuit 2, the dividing resistors 12 and 13, and the comparison circuit 14 may be omitted.

When the switching-mode power supply 30 having the above configuration operates normally, that is, when a half short-circuit does not occur in the main switching element Q1, the switch SW1 continues to be closed. While the switch SW1 continues to be closed, the switching-mode power supply 30 operates in the same manner as the general switching-mode power supply 130 illustrated in FIG. 7.

That is, an alternating current voltage is input to the commercial power supply input terminal 5, a noise component is removed from the alternating current voltage, the alternating current voltage is subjected to bridge-rectification by the diode bridge 4, smoothed by the input smoothing capacitor 1, and is supplied to the primary winding n1 of the transformer 8. Switching of the main switching element Q1 allows high-frequency alternating current energy (excitation energy) to be transmitted as an alternating current voltage from the primary winding n1 to the secondary winding n2 of the transformer 8. The alternating current voltage transmitted to the secondary winding n2 is subjected to half-wave rectification by the diode 9 and smoothed by the output smoothing capacitor 10, and then output from the output terminals 11 as a direct current voltage. Further, the control circuit 2 controls switching cycle of the main switching element Q1 based on the result of the comparison from the comparison circuit 14 so that the switching-mode power supply 30 outputs a predetermined voltage.

The following explains how the switching-mode power supply 30 operates when the half short-circuit occurs in the main switching element Q1.

When the half short-circuit occurs in the main switching element Q1, a ripple voltage of a smoothed voltage that appears at both sides of the input smoothing capacitor 1 increases.

How the ripple voltage increases due to occurrence of the half short-circuit in the main switching element Q1 is as follows.

When the half short-circuit occurs in the main switching element Q1, more current flows in the main switching element Q1. Consequently, more current flows in the input smoothing capacitor 1, and accordingly the ripple voltage of the smoothed voltage that appears at both sides of the input smoothing capacitor 1 increases.

An example of a method for preventing the increase in the alternating current ripple component is making capacitance of the input smoothing capacitor 1 sufficiently large. However, if this method would be adopted, then circuit size and costs of the switching-mode power supply of the present invention would increase. Therefore, it is unrealistic to make the capacitance of the input smoothing capacitor 1 sufficiently large to such an extent that smoothing by the input smoothing capacitor 1 removes the alternating current ripple component completely. That is, the capacitance of the input smoothing capacitor 1 is determined according to how far the increase in the ripple voltage is allowed (allowable value of the ripple voltage).

When the alternating current ripple component exceeds the allowable value of the ripple voltage, it is impossible to completely remove the alternating current ripple component. When the alternating current ripple component in the smoothed voltage increases more, the ripple voltage increases similarly with the alternating current ripple component.

The ripple voltage detecting circuit 15 monitors appearance of the ripple voltage at both sides of the input smoothing capacitor 1. The ripple voltage detecting circuit 15 detects the half short-circuit in the main switching element Q1 by detecting that a variation width of a potential in the power supply line A has a predetermined value or more. When the ripple voltage detecting circuit 15 detects that the ripple voltage has a predetermined amount or more, the ripple voltage detecting circuit 15 transmits a signal for causing the switching SW1 to be opened.

In the present embodiment, as described above, the ripple voltage detecting circuit 15 detects the half short-circuit in the main switching element Q1 by detecting that the ripple voltage has a predetermined amount or more. However, the method with which the ripple voltage detecting circuit 15 detects the half short-circuit in the main switching element Q1 is not limited to this. For example, the half short-circuit in the main switching element Q1 may be detected by measuring potential difference between the drain and the gate of the main switching element Q1.

The switch SW1 is opened in response to the signal from the ripple voltage detecting circuit 15, and thus blocks supply of a current (supply of a voltage) to the main switching element Q1.

Therefore, with a simple circuit configuration and with low costs, it is possible to prevent overheating of the switching-mode power supply 30 due to the half short-circuit in the main switching element Q 1 and to avoid an unstable state of the switching-mode power supply 30.

### Embodiment 2

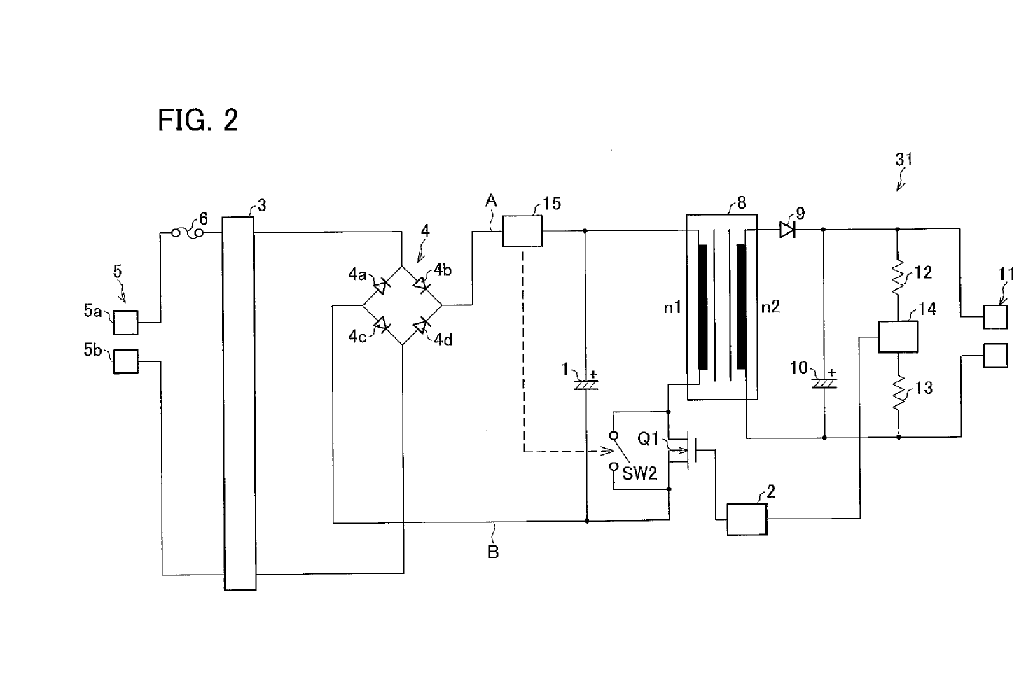

The following explains a switching-mode power supply of another embodiment of the present invention with reference to FIG. 2.

A switching-mode power supply 31 illustrated in FIG. 2 is the same as the switching-mode power supply 30 illustrated in FIG. 1 except that the switching-mode power supply 31 includes a switch SW2 (short-circuit switch means, main switching element short-circuit switch means) instead of the switch SW1. The switch SW2 is provided between the source and the drain of the main switching element Q1 so that the switch SW2 is connected in parallel with the main switching element Q1. That is, a parallel circuit consisting of the main switching element Q1 and the switch SW2 and a primary winding n1 of a transformer 8 are connected in series with each other between power supply lines A and B. When the switching-mode power supply 31 operates normally, that is, when a half short-circuit does not occur in the main switching element Q1, the switch SW2 continues to be opened. While the switch SW2 continues to be opened, the switching-mode power supply 31 operates in the same manner as the general switching-mode power supply 130 illustrated in FIG. 7.

Configuration of the switch SW2 may be the same as that of the switch SW1 used in Embodiment 1. That is, the switch SW2 may be any well-known switch as long as it can switch between on and off in response to a signal transmitted from a ripple voltage detecting circuit 15.

The ripple voltage detecting circuit 15 controls opening/closing of the switch SW2.

When the half short-circuit occurs in the main switching element Q1, a ripple voltage of a smoothed voltage appearing at both sides of an input smoothing capacitor 1 increases. When the ripple voltage detecting circuit 15 detects that the ripple voltage has a predetermined amount or more, the ripple voltage detecting circuit 15 outputs a signal for causing the switch SW2 to be closed.

The switch SW2 is closed in response to the signal from the ripple voltage detecting circuit 15. When the switch SW2 continues to be closed, a short-circuit occurs between the power supply lines A and B, and a current that is not less than a rated current (e.g. a current that is two times or more larger than the rated current) flows in a fuse 6. This allows the fuse 6 to melt quickly, immediately stopping an operation of the switching-mode power supply 31.

Therefore, with a simple circuit configuration and with low costs, it is possible to prevent overheating of the switching-mode power supply 31 due to the half short-circuit in the main switching element Q 1 and to avoid an unstable state of the switching-mode power supply 31.

### Embodiment 3

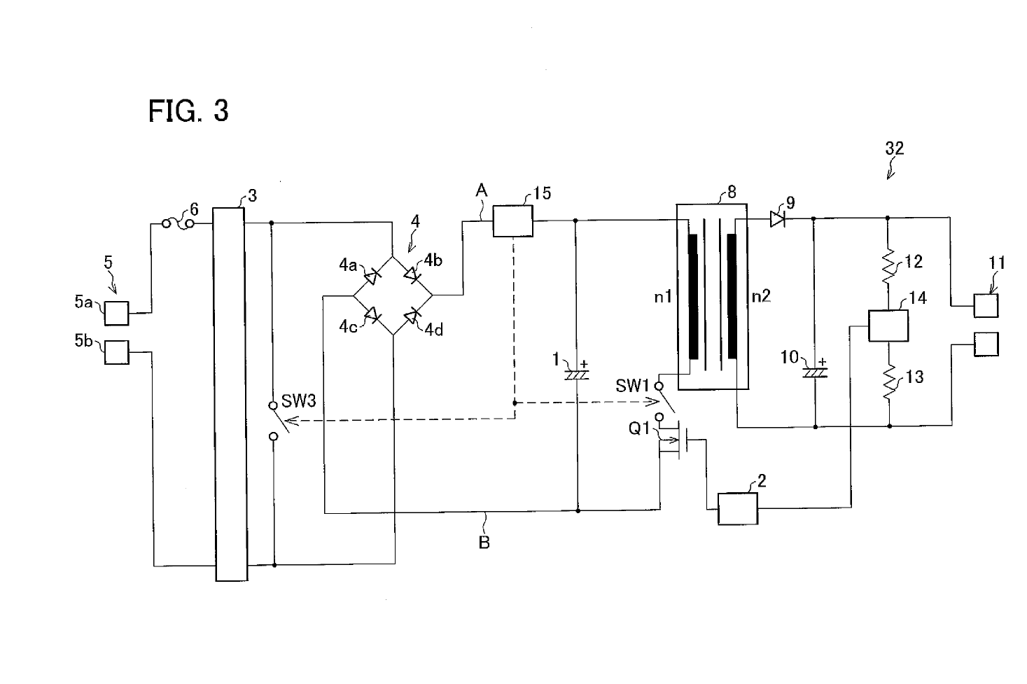

The following explains a switching-mode power supply of further another embodiment of the present invention with reference to FIG. 3.

A switching-mode power supply 32 illustrated in FIG. 3 includes a switch SW3 (filter short-circuit switch means) in addition to the circuit configuration of the switching-mode power supply 30 illustrated in FIG. 1. The switch SW3 is connected between output terminals of a filter circuit 3 so that the switch SW3 is connected in parallel with the filter circuit 3. When the switching-mode power supply 32 operates normally, that is, when a half short-circuit does not occur in the main switching element Q1, the switch SW3 continues to be opened. While the switch SW3 continues to be opened, the switching-mode power supply 32 operates in the same manner as the general switching-mode power supply 130 illustrated in FIG. 7.

Configuration of the switch SW3 may be the same as that of the switch SW1. That is, the switch SW3 may be any well-known switch as long as it can switch between on and off in response to a signal transmitted from a ripple voltage detecting circuit 15.

The ripple voltage detecting circuit 15 controls opening/closing of the switch SW3 as well as the switch SW1.

When the half short-circuit occurs in the main switching element Q1, a ripple voltage of a smoothed voltage appearing at both sides of an input smoothing capacitor 1 increases. When the ripple voltage detecting circuit 15 detects that the ripple voltage has a predetermined amount or more, the ripple voltage detecting circuit 15 outputs a signal for causing the switch SW1 to be opened and outputs a signal for causing the switch SW3 to be closed.

The switch SW1 is opened in response to the signal from the ripple voltage detecting circuit 15, thereby blocking supply of a current (supply of a voltage) to the main switching element Q1.

Further, the switch SW3 is closed in response to the signal from the ripple voltage detecting circuit 15. When the switch SW3 continues to be closed, a short-circuit occurs in the filter circuit 3. That is, a very large current flows between input terminals 5a and 5b via the switch SW3. Along with it, a current that is not less than a rated current (e.g. a current that is two times or more larger than the rated current) flows in a fuse 6. This allows the fuse 6 to melt quickly, immediately stopping an operation of the switching-mode power supply 32.

Therefore, with a simple circuit configuration and with low costs, it is possible to prevent overheating of the switching-mode power supply 32 due to the half short-circuit in the main switching element Q1 and to avoid an unstable state of the switching-mode power supply 32.

In the present embodiment, an explanation was made as to a case where both of the switches SW1 and SW3 are provided. However, both of the switches SW1 and SW3 are not necessarily provided. For example, only the switch SW3 may be provided. Further, in the switching-mode power supply in the present embodiment, the switch SW2 explained in Embodiment 2 and the switch SW3 may be provided.

### Embodiment 4

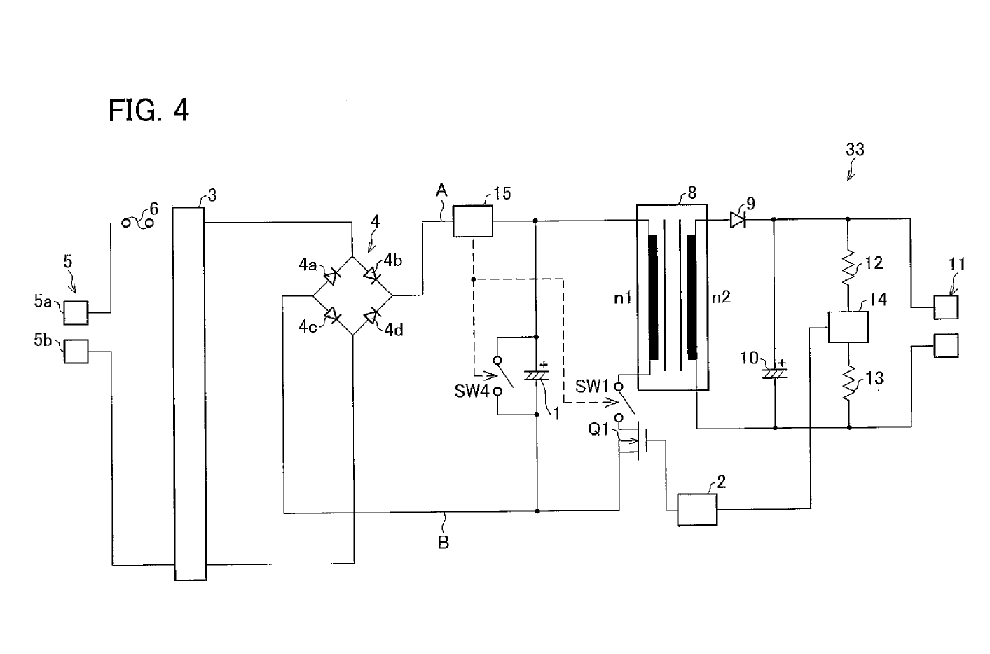

The following explains a switching-mode power supply of further another embodiment of the present invention with reference to FIG. 4.

A switching-mode power supply 33 illustrated in FIG. 4 includes a switch SW4 (short-circuit switch means, capacitor short-circuit switch means) in addition to the circuit configuration of the switching-mode power supply 30 illustrated in FIG. 1. The switch SW4 is connected with both ends of an input smoothing capacitor 1 so that the switch SW4 is connected in parallel with the input smoothing capacitor 1. When the switching-mode power supply 33 operates normally, that is, when a half short-circuit does not occur in the main switching element Q1, the switch SW4 continues to be opened. While the switch SW4 continues to be opened, the switching-mode power supply 33 operates in the same manner as the general switching-mode power supply 130 illustrated in FIG. 7.

Configuration of the switch SW4 may be the same as that of the switch SW1. That is, the switch SW4 may be any well-known switch as long as it can switch between on and off in response to a signal transmitted from a ripple voltage detecting circuit 15.

The ripple voltage detecting circuit 15 controls opening/closing of the switch SW4 as well as the switch SW1.

When the half short-circuit occurs in the main switching element Q1, a ripple voltage of a smoothed voltage appearing at both sides of an input smoothing capacitor 1 increases. When the ripple voltage detecting circuit 15 detects that the ripple voltage has a predetermined amount or more, the ripple voltage detecting circuit 15 outputs a signal for causing the switch SW1 to be opened and outputs a signal for causing the switch SW4 to be closed.

The switch SW1 is opened in response to the signal from the ripple voltage detecting circuit 15, thereby blocking supply of a current (supply of a voltage) to the main switching element Q1.

Further, the switch SW4 is closed in response to the signal from the ripple voltage detecting circuit 15. When the switch SW4 continues to be closed, a short-circuit occurs between the terminals of the input smoothing capacitor 1. This causes a short-circuit between power supply lines A and B. Along with it, a current that is not less than a rated current (e.g. a current that is two times or more larger than the rated current) flows in a fuse 6. This allows the fuse 6 to melt quickly, immediately stopping an operation of the switching-mode power supply 33.

Therefore, with a simple circuit configuration and with low costs, it is possible to prevent overheating of the switching-mode power supply 33 due to the half short-circuit in the main switching element Q1 and to avoid an unstable state of the switching-mode power supply 33.

In the present embodiment, an explanation was made as to a case where both of the switches SW1 and SW4 are provided. However, combination of switches is not limited to this case. For example, the switch SW3 explained in Embodiment 3 may be further provided, or only the switch SW4 may be provided. Further, the switching-mode power supply 33 may be arranged so as to include (i) the switch SW4 and (ii) one or both of the switch SW2 explained in Embodiment 2 and the switch SW3.

That is, all combinations are possible among the switches SW1 to SW4 in Embodiments 1 to 4 except for a combination including both the switches SW1 and SW2.

### Embodiment 5

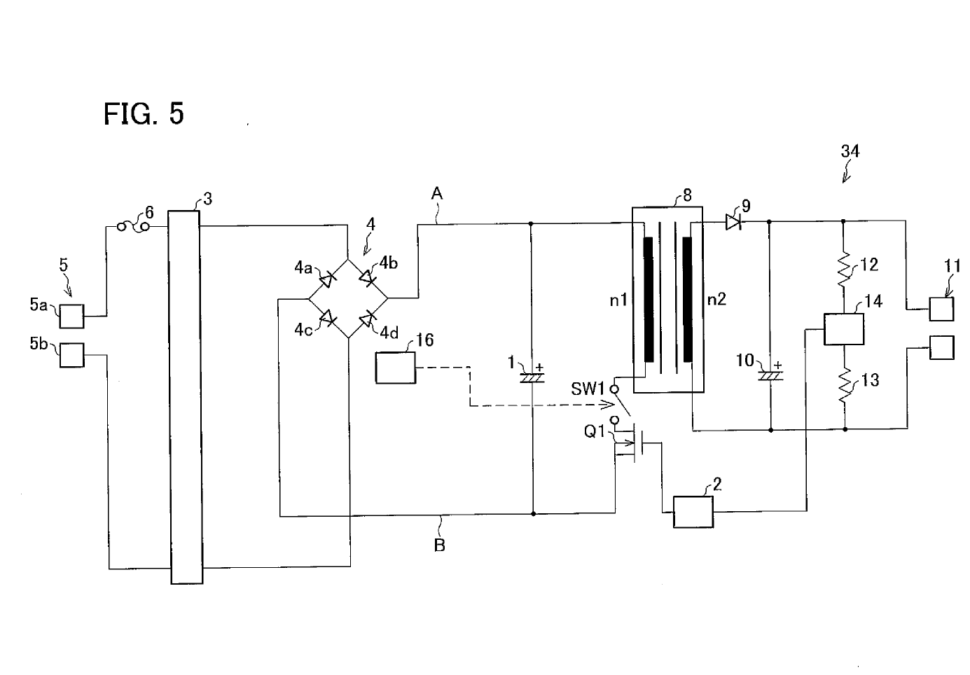

The following explains a switching-mode power supply of further another embodiment of the present invention with reference to FIG. 5.

A switching-mode power supply 34 illustrated in FIG. 5 is the same as the switching-mode power supply 30 illustrated in FIG. 1 except that the switching-mode power supply 34 includes a temperature detecting circuit 16 instead of the ripple voltage detecting circuit 15.

The temperature detecting circuit 16 is provided near the diode bridge 4 and detects the temperature of the diode bridge 4. The temperature detecting circuit 16 is not particularly limited as long as it can detect the temperature of the diode bridge 4. An example of the temperature detecting circuit 16 is a temperature detecting circuit using a thermocouple. In the case of the temperature detecting circuit using a thermocouple, for example, one end of the thermocouple is provided near the surface of the diode bridge 4 without touching the surface or provided on the surface so as to touch the surface, and the other end of the thermocouple is connected with the temperature detecting circuit 16, so that the temperature of the surface of the package of the diode bridge 4 is detected. Thus, the temperature of the diode bridge 4 is detected. Another example of the temperature detecting circuit 16 is a temperature detecting circuit using a thermistor. In the case of the temperature detecting circuit using a thermistor, for example, the thermistor is provided near the surface of the diode bridge 4 without touching the surface or provided on the surface so as to touch the surface, and the thermistor is connected with the temperature detecting circuit 16, so that the temperature of the surface of the package of the diode bridge 4 is detected. Thus, the temperature of the diode bridge 4 is detected.

The temperature detecting circuit 16 monitors the result of detecting the temperature of the diode bridge 4. When the detected temperature has a predetermined value or more, the temperature detecting circuit 16 outputs, to the switch SW1, a control signal for causing the switch SW1 to be opened.

That is, when the half short-circuit occurs in the main switching element Q1, more current flows between power supply lines A and B. Consequently, more current flows in the diode bridge 4, and as a result the temperature of the diode bridge 4 increases The temperature detecting circuit 16 detects the half short-circuit in the main switching element Q1 by detecting that the temperature of the diode bridge 4 has a predetermined value or more, and causes the switch SW1 to be opened. Thus, the switching-mode power supply of the present embodiment blocks supply of a current to the main switching element Q1 where the half short-circuit occurs, as with Embodiment 1.

Therefore, with a simple circuit configuration and with low costs, it is possible to prevent overheating of the switching-mode power supply 34 due to the half short-circuit in the main switching element Q1 and to avoid an unstable state of the switching-mode power supply 34.

In the present embodiment, an explanation was made as to a case where the half short-circuit in the main switching element Q1 is detected by detecting the temperature of the diode bridge 4. However, the present embodiment is not limited to this case. The switching-mode power supply of the present embodiment may be arranged so that the temperature detecting circuit 16 is provided near the switching element Q1 and the temperature detecting circuit 16 detects the temperature of the switching element Q1 so as to detect the half short-circuit in the main switching element Q1. Further, the switching-mode power supply of the present embodiment may be arranged so that the temperature detecting circuit 16 is provided near the filter circuit 3 and the temperature detecting circuit 16 detects the temperature of a line filter (not shown) provided in the filter circuit 3 so as to detect the half short-circuit in the main switching element Q1.

Further, in the present embodiment, an explanation was made as to a case where the switching-mode power supply of the present embodiment is the same as the switching-mode power supply 30 in Embodiment 1 except that the switching-mode power supply of the present embodiment includes the temperature detecting circuit 16 instead of the ripple voltage detecting circuit 15. However, the present embodiment is not limited to this case. For example, the switching-mode power supply of the present embodiment may be the same as any one of the switching-mode power supplies 31 to 33 in Embodiments 2 to 4, respectively, except that the switching-mode power supply of the present embodiment includes the temperature detecting circuit 16 instead of the ripple voltage detecting circuit 15. At that time, substantially the same effect as those of Embodiments 2 to 4 can be obtained.

Further, the present embodiment may be combined with Embodiments 1 to 4. That is, the switching-mode power supply of the present embodiment may be arranged so that the ripple voltage detecting circuit 15 is further provided, and when the ripple voltage detecting circuit 15 detects an increase in a ripple voltage or the temperature detecting circuit 16 detects an increase in the temperature of the diode bridge 4, the ripple voltage detecting circuit 15 or the temperature detecting circuit 16 outputs to the switch SW1 a control signal for causing the switch SW1 to be opened.

### Embodiment 6

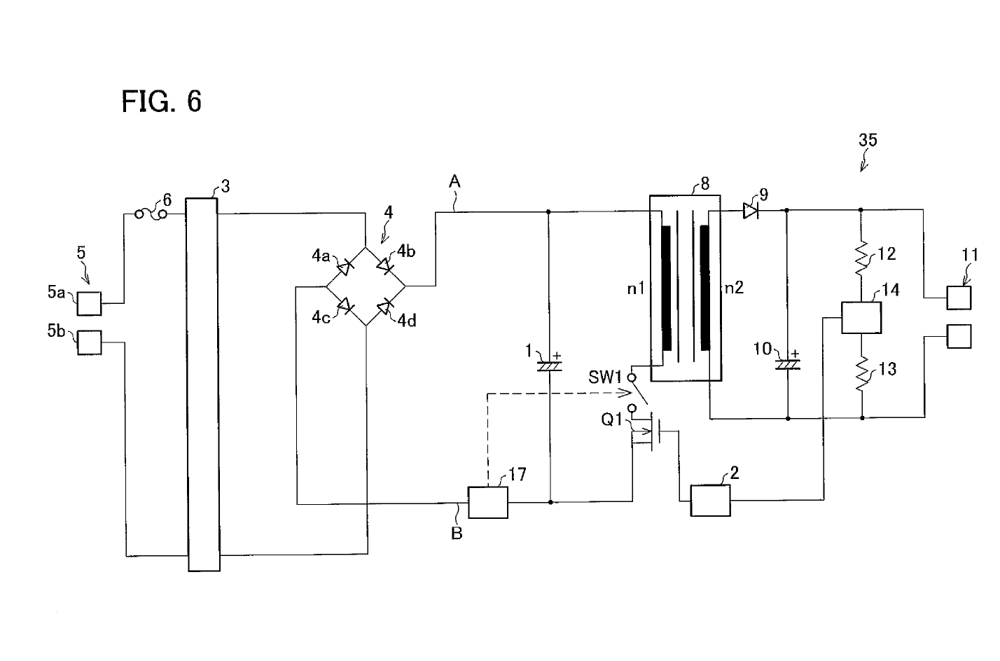

The following explains a switching-mode power supply of further another embodiment of the present invention with reference to FIG. 6.

A switching-mode power supply 35 illustrated in FIG. 6 is the same as the switching-mode power supply 30 illustrated in FIG. 1 except that the switching-mode power supply 35 includes, instead of the ripple voltage detecting circuit 15, a current detecting circuit 17 connected in series with a power supply line B at the low level side. To be more specific, the current detecting circuit 17 is provided in the power supply line B so that the current detecting circuit 17 is connected in series between (i) a connecting point between an input smoothing capacitor 1 and the power supply line B and (ii) a diode bridge 4.

The current detecting circuit 17 detects a current flowing in the power supply line B. When a current of not less than a predetermined amount flows, the current detecting circuit 17 outputs, to a switch SW1, a control signal for causing the switch SW1 to be opened. The current detecting circuit 17 may be configured as follows.

That is, a resistor with minute resistance is connected in series with the power supply line B, and a fall voltage at both sides of the resistor is detected. When the fall voltage is a predetermined voltage or more (e.g. a voltage two times larger than a voltage at rated operation), it is judged that a current of not less than a predetermined amount flows in the power supply line B. Thus, the current detecting circuit 17 detects a half short-circuit in the main switching element Q1.

When the half short-circuit occurs in the main switching element Q1, more current flows in the power supply line B. The current detecting circuit 17 detects the half short-circuit in the main switching element Q1 by detecting that a current of not less than a predetermined amount flows in the power supply line B, and accordingly the current detecting circuit 17 causes the switch SW1 to be opened. Thus, the switching-mode power supply 35 blocks supply of a current to the main switching element Q1 where the half short-circuit occurs, in the similar manner as Embodiment 1.

Therefore, with a simple circuit configuration and with low costs, it is possible to prevent overheating of the switching-mode power supply 35 due to the half short-circuit in the main switching element Q1 and to avoid an unstable state of the switching-mode power supply 35.

In the present embodiment, an explanation was made as to a case where the half short-circuit in the main switching element Q1 is detected by detecting that a current of not less than a predetermined amount flows in the power supply line B. However, the present embodiment is not limited to this case. The current detecting circuit 17 may be provided at any part of the switching-mode power supply 35 as long as a current flows in the part.

Further, in the present embodiment, an explanation was made as to a case where the switching-mode power supply of the present embodiment is the same as the switching-mode power supply 30 in Embodiment 1 except that the switching-mode power supply of the present embodiment includes the current detecting circuit 17 instead of the ripple voltage detecting circuit 15. However, the present embodiment is not limited to this case. For example, the switching-mode power supply of the present embodiment may be the same as any one of the switching-mode power supplies 31 to 33 in Embodiments 2 to 4, respectively, except that the switching-mode power supply of the present embodiment includes the current detecting circuit 17 instead of the ripple voltage detecting circuit 15. In this case, substantially the same effect as Embodiments 2 to 4 can be obtained.

Further, the present embodiment may be combined with Embodiments 1 to 5. That is, the switching-mode power supply 35 illustrated in FIG. 6 may be arranged so that the switching-mode power supply 35 further includes the ripple voltage detecting circuit 15 and/or the temperature detecting circuit 16, and when (i) an increase in a current flowing in the power supply line B and (ii) an increase in a ripple voltage (in the case where the ripple voltage detecting circuit 15 is provided) and/or an increase in the temperature of the diode bridge 4 (in the case where the temperature detecting circuit 16 is provided) are detected, the switching-mode power supply 35 outputs, to the switch SW1, a control signal for causing the switch SW1 to be opened.

In each of Embodiments 1 to 6, an explanation was made as to the switching-mode power supply (AC-DC converter) that converts an input commercial alternating current voltage to a direct current voltage. However, the present invention is not limited to such switching-mode power supply. For example, the present invention may be applicable to a switching-mode power supply (DC-DC converter) that transforms an input direct current voltage into another direct current voltage and outputs the direct current voltage thus transformed. In this case, the switching-mode power supply may be arranged so that the diode bridge 4 and the filter circuit 3 are omitted, one terminal of the fuse 6 is connected with the first terminal 5a of the power supply input terminal 5, the other terminal of the fuse 6 is connected with the power supply line A, and the second terminal 5b of the power supply input terminal 5 is connected with the power supply line B.

Further, in a case where there is no necessity to remove a noise component in Embodiments 1 to 6, the filter circuit 3 may be omitted.

The switching-mode power supply of the aforementioned embodiment may be interpreted as a switching-mode power supply, including: a transformer with primary and secondary windings, for transmitting, as an alternating current voltage, a voltage applied on the primary winding to the secondary winding; a main switching circuit (main switching means) to be switched between a state where a voltage is applied on the primary winding and a state where the voltage is transmitted as an alternating current voltage to the secondary winding; and an output circuit (output means) for rectifying and smoothing the alternating current voltage so as to output a direct current voltage, the switching-mode power supply including: a detecting circuit (detecting means) for detecting a half short-circuit in the main switching circuit; and a current supply blocking switch circuit (current supply blocking switch means), connected in series with the main switching circuit, which is capable of being nonconductive so as to block supply of a current to the main switching circuit, the detecting circuit causing the current supply blocking switch circuit to be nonconductive when the detecting circuit detects a half short-circuit in the main switching circuit.

With the arrangement, the current supply blocking switch circuit is caused to be conductive at a time of normal operation (at a time when a half short-circuit does not occur in the main switching circuit). Consequently, the main switching circuit can be switched between a state where a voltage is applied on the primary winding and a state where the voltage is transmitted as an alternating current voltage to the secondary winding. On the other hand, when the detecting circuit detects the half short-circuit in the main switching circuit, the current supply blocking switch circuit is opened to be nonconductive. Thus, supply of a current to the main switching circuit is blocked.

Accordingly, with a simple circuit configuration and with low costs, it is possible to prevent overheating of the switching-mode power supply due to the half short-circuit in the main switching element and to avoid an unstable state of the switching-mode power supply.

The switching-mode power supply of the aforementioned embodiment may be interpreted as a switching-mode power supply, including: an input section with first and second terminals, connected with a voltage source; an overcurrent blocking circuit (overcurrent blocking means) connected in series with one of the first and second terminals in a stage after the input section; a transformer with primary and secondary windings, for transmitting, as an alternating current voltage, a voltage applied on the primary winding to the secondary winding; a main switching circuit to be switched between a state where a voltage is applied on the primary winding and a state where the voltage is transmitted as an alternating current voltage to the secondary winding; and an output circuit for rectifying and smoothing the alternating current voltage so as to output a direct current voltage, the switching-mode power supply including: a detecting circuit for detecting a half short-circuit in the main switching circuit; and a short-circuit switch circuit (short-circuit switch means) capable of being conductive so as to cause a short-circuit between two power supply lines connected with the primary winding, the detecting circuit causing the short-circuit switch circuit to be conductive when the detecting circuit detects a half short-circuit in the main switching circuit.

With the arrangement, the switching-mode power supply includes: the detecting circuit for detecting the half short-circuit occurring in the main switching circuit: and the short-circuit switch circuit. At a time of normal operation, the short-circuit switch circuit is caused to be nonconductive. Consequently, a current of not more than a predetermined amount (e.g. a current two times larger than a rated current) flows in the overcurrent blocking circuit. On the other hand, when the detecting circuit detects the half short-circuit occurring in the main switching circuit, the short-circuit switch circuit is closed to be conductive. Consequently, more current flows in the overcurrent blocking circuit, allowing the overcurrent blocking circuit to melt quickly. Thus, it is possible to promptly stop an operation of the switching-mode power supply of the present invention.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply of the aforementioned embodiment may be arranged so that the short-circuit switch circuit is connected in parallel with the main switching circuit.

With the arrangement, the short-circuit switch circuit is connected in parallel with the main switching circuit. Consequently, when the short-circuit switch circuit is closed, i.e. when the short-circuit switch circuit is conductive, the main switching circuit is bypassed. When the main switching circuit is bypassed, the power source lines are short-circuited, allowing a current of not less than a predetermined amount to flow in the overcurrent blocking circuit instantly. This allows the overcurrent blocking circuit to melt quickly, thereby stopping an operation of the switching-mode power supply quickly.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply of the aforementioned embodiment may be arranged so that the short-circuit switch circuit is connected in parallel with an input smoothing capacitor for smoothing a voltage to be applied on the primary winding.

With the arrangement, the short-circuit switch circuit is connected in parallel with the input smoothing capacitor. Consequently, when the short-circuit switch circuit is closed, i.e. when the short-circuit switch circuit is conductive, the input smoothing capacitor is bypassed. When the input smoothing capacitor is bypassed, the power source lines are short-circuited, allowing a current of not less than a predetermined amount to flow in the overcurrent blocking circuit instantly. This allows the overcurrent blocking circuit to melt quickly, thereby stopping an operation of the switching-mode power supply quickly.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply may be arranged so as to further include a current supply blocking switch circuit, connected in series with the main switching circuit, which is capable of being nonconductive so as to block supply of a current to the main switching circuit, the detecting circuit causing the current supply blocking switch circuit to be nonconductive when the detecting circuit detects a half short-circuit in the main switching circuit.

With the arrangement, the current supply blocking switch circuit is caused to be conductive at a time of normal operation. Accordingly, the main switching circuit can be switched between a state where a voltage is applied on the primary winding of the transformer and a state where the voltage is transmitted as an alternating current voltage of the secondary winding of the transformer. On the other hand, when the detecting circuit detects a half short-circuit occurring in the main switching circuit, the current supply blocking switch circuit is opened to be nonconductive. Consequently, it is possible to block application of a voltage to the main switching circuit.

Therefore, with a simple circuit configuration and with low costs, it is possible to prevent overheating of the switching-mode power supply due to the half short-circuit in the main switching element and to avoid an unstable state of the switching-mode power supply.

The switching-mode power supply of the aforementioned embodiment may be interpreted as a switching-mode power supply, including: an input section with first and second terminals, connected with a voltage source; an overcurrent blocking circuit connected in series with one of the first and second terminals in a stage after the input section; a filter circuit connected between a series circuit and the second terminal of the input section, the series circuit consisting of the first terminal of the input section and the overcurrent blocking circuit; a transformer with primary and secondary windings, for transmitting, as an alternating current voltage, a voltage applied on the primary winding to the secondary winding; a main switching circuit to be switched between a state where a voltage is applied on the primary winding and a state where the voltage is transmitted as an alternating current voltage to the secondary winding; and an output circuit for rectifying and smoothing the alternating current voltage so as to output a direct current voltage, the switching-mode power supply including: a detecting circuit for detecting a half short-circuit in the main switching circuit; and a filter short-circuit switch circuit (filter short-circuit switch means), connected in parallel with the filter circuit, which is capable of being conductive so as to cause a short-circuit between two output terminals of the filter circuit, the detecting circuit causing the filter short-circuit switch circuit to be conductive when the detecting circuit detects a half short-circuit in the main switching circuit.

With the arrangement, the filter short-circuit switch circuit is caused to be nonconductive at a time of normal operation. Consequently, a current of not more than a predetermined amount (e.g. a current two times larger than a rated current) flows in the overcurrent blocking circuit. On the other hand, when the detecting circuit detects the half short-circuit occurring in the main switching circuit, the short-circuit switch circuit is closed to be conductive. At that time, a short-circuit occurs between output terminals of the filter circuit. That is, a very large current flows between the first and second terminals of the input section. Consequently, a current of not less than a predetermined amount instantly flows in the overcurrent blocking circuit. This allows the overcurrent blocking circuit to melt quickly, thereby stopping an operation of the switching-mode power supply promptly.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply may be arranged so as to further include a current supply blocking switch circuit, connected in series with the main switching circuit, which is capable of being nonconductive so as to block supply of a current to the main switching circuit, the detecting circuit causing the current supply blocking switch circuit to be nonconductive when the detecting circuit detects a half short-circuit in the main switching circuit.

With the arrangement, the current supply blocking switch circuit is caused to be conductive at a time of normal operation. Accordingly, the main switching circuit can be switched between a state where a voltage is applied on the primary winding of the transformer and a state where the voltage is transmitted as an alternating current voltage of the secondary winding of the transformer. On the other hand, when the detecting circuit detects a half short-circuit occurring in the main switching circuit, the current supply blocking switch circuit is opened to be nonconductive. Consequently, it is possible to block application of a voltage to the main switching circuit.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply of the aforementioned embodiment may be arranged so as to further include a main switching element short-circuit switch circuit (main switching element short-circuit switch means), connected in parallel with the main switching circuit, which is capable of being conductive so as to cause a short-circuit between two power supply lines connected with the primary winding, the detecting circuit causing the main switching element short-circuit switch circuit to be conductive when the detecting circuit detects a half short-circuit in the main switching circuit.

With the arrangement, the main switching element short-circuit switch circuit is caused to be nonconductive at a time of normal operation. Accordingly, a current that is not more than a predetermined current (e.g. a current two times larger than a rated current) flows in the overcurrent blocking circuit. On the other hand, when the detecting circuit detects the half short-circuit in the main switching circuit, the main switching element short-circuit switch circuit is closed to be conductive. At that time, the main switching circuit is bypassed. When the main switching circuit is bypassed, the power source lines are short-circuited, and a current that is not less than the predetermined current flows instantly in the overcurrent blocking circuit. This allows the overcurrent blocking circuit to melt quickly, thereby stopping an operation of the switching-mode power supply promptly.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply of the aforementioned embodiment may be arranged so as to further include a capacitor short-circuit switch circuit (capacitor short-circuit switch means) capable of being conductive so as to cause a short-circuit between both ends of an input smoothing capacitor for smoothing a voltage to be applied on the primary winding, the detecting circuit causing the capacitor short-circuit switch circuit to be conductive when the detecting circuit detects a half short-circuit in the main switching circuit.

With the arrangement, the capacitor short-circuit switch circuit is caused to be nonconductive at a time of normal operation. Accordingly, a current that is not more than a predetermined current (e.g. a current two times larger than a rated current) flows in the overcurrent blocking circuit. On the other hand, when the detecting circuit detects the half short-circuit in the main switching circuit, the capacitor short-circuit switch circuit is closed to be conductive. At that time, the input smoothing capacitor is bypassed. When the input smoothing capacitor is bypassed, the power source lines are short-circuited, and a current that is not less than the predetermined current flows instantly in the overcurrent blocking circuit. This allows the overcurrent blocking circuit to melt quickly, thereby stopping an operation of the switching-mode power supply promptly.

Therefore, with a simple circuit configuration and with low costs, it is possible to prevent overheating of the switching-mode power supply due to the half short-circuit in the main switching element and to avoid an unstable state of the switching-mode power supply.

Further, the switching-mode power supply of the aforementioned embodiment may be arranged so that the detecting circuit detects a half short-circuit in the main switching circuit by detecting that a voltage smoothed by an input smoothing capacitor for smoothing a voltage to be applied on the primary winding has a predetermined variation width or more.

When the half short-circuit occurs in the main switching circuit, a ripple voltage (an alternating current ripple component included in a direct current voltage output) occurs in the input smoothing capacitor. With the arrangement, the switching-mode power supply detects occurrence of the ripple voltage by detecting that the voltage smoothed by the input smoothing capacitor for smoothing a voltage to be applied on the primary winding has a predetermined variation width or more. Thus, the switching-mode power supply can detect indirectly that the half short-circuit occurs in the main switching circuit.

Further, the switching-mode power supply of the aforementioned embodiment may be arranged so that the detecting circuit detects a half short-circuit in the main switching circuit by detecting that a current of a predetermined amount or more flows in an input smoothing capacitor for smoothing a voltage to be applied on the primary winding.

When a half short-circuit occurs in the main switching circuit, more current flows in the switching-mode power supply. With the arrangement, the switching-mode power supply detects that a current of a predetermined amount or more flows in the input smoothing capacitor for smoothing a voltage to be applied on the primary winding. Thus, the switching-mode power supply indirectly detects a half short-circuit in the main switching circuit.

Further, the switching-mode power supply of the aforementioned embodiment may be arranged so that the detecting circuit detects a half short-circuit in the main switching circuit by detecting that a rectifying circuit (rectifying means) has a predetermined temperature or more, the rectifying circuit being provided for rectifying an input alternating current voltage in a stage before an input smoothing capacitor for smoothing a voltage to be applied on the primary winding.

When a half short-circuit occurs in the main switching circuit, more current flows in the rectifying circuit for rectifying an input alternating current voltage in the stage before the input smoothing capacitor for smoothing a voltage to be applied on the primary winding. Consequently, the temperature of the rectifying circuit increases compared with a time when the switching-mode power supply operates normally. With the arrangement, the detecting circuit detects that the rectifying circuit has a predetermined temperature or mores and thus indirectly detects the half short-circuit in the main switching circuit.

The switching-mode power supply of the aforementioned embodiment is applicable to an AC-DC converter and a DC-DC converter for example.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A switching-mode power supply, including: a transformer with primary and secondary windings, for transmitting, as an alternating current voltage, a voltage applied on the primary winding to the secondary winding; main switching means to be switched between a state where a voltage is applied on the primary winding and a state where the voltage is transmitted as an alternating current voltage to the secondary winding; and output means for rectifying and smoothing the alternating current voltage so as to output a direct current voltage,
said switching-mode power supply comprising:
detecting means for detecting a half short-circuit in the main switching means; and
current supply blocking switch means, connected in series with the main switching means, which is capable of being nonconductive so as to block supply of a current to the main switching means,
the detecting means causing the current supply blocking switch means to be nonconductive when the detecting means detects a half short-circuit in the main switching means.

2. The switching-mode power supply as set forth in claim 1, wherein the detecting means detects a half short-circuit in the main switching means by detecting that a voltage smoothed by an input smoothing capacitor for smoothing a voltage to be applied on the primary winding has a predetermined variation width or more.

3. The switching-mode power supply as set forth in claim 1, wherein the detecting means detects a half short-circuit in the main switching means by detecting that a current of a predetermined amount or more flows in an input smoothing capacitor for smoothing a voltage to be applied on the primary winding.

4. A switching-mode power supply, including: an input section with first and second terminals, connected with a voltage source; overcurrent blocking means connected in series with one of the first and second terminals in a stage after the input section; a transformer with primary and secondary windings, for transmitting, as an alternating current voltage, a voltage applied on the primary winding to the secondary winding; main switching means to be switched between a state where a voltage is applied on the primary winding and a state where the voltage is transmitted as an alternating current voltage to the secondary winding; and output means for rectifying and smoothing the alternating current voltage so as to output a direct current voltage,
said switching-mode power supply comprising:
detecting means for detecting a half short-circuit in the main switching means; and
short-circuit switch means capable of being conductive so as to cause a short-circuit between two power supply lines connected with the primary winding,
the detecting means causing the short-circuit switch means to be conductive when the detecting means detects a half short-circuit in the main switching means.

5. The switching-mode power supply as set forth in claim 4, wherein the short-circuit switch means is connected in parallel with the main switching means.

6. The switching-mode power supply as set forth in claim 4, wherein the short-circuit switch means is connected in parallel with an input smoothing capacitor for smoothing a voltage to be applied on the primary winding.

7. The switching-mode power supply as set forth in claim 4, wherein the detecting means detects a half short-circuit in the main switching means by detecting that a voltage smoothed by an input smoothing capacitor for smoothing a voltage to be applied on the primary winding has a predetermined variation width or more.

8. The switching-mode power supply as set forth in claim 4, wherein the detecting means detects a half short-circuit in the main switching means by detecting that a current of a predetermined amount or more flows in an input smoothing capacitor for smoothing a voltage to be applied on the primary winding.

9. The switching-mode power supply as set forth in claim 4, wherein the detecting means detects a half short-circuit in the main switching means by detecting that rectifying means has a predetermined temperature or more, the rectifying means being provided for rectifying an input alternating current voltage in a stage before an input smoothing capacitor for smoothing a voltage to be applied on the primary winding.

10. The switching-mode power supply as set forth in claim 6, further comprising current supply blocking switch means, connected in series with the main switching means, which is capable of being nonconductive so as to block supply of a current to the main switching means,
the detecting means causing the current supply blocking switch means to be nonconductive when the detecting means detects a half short-circuit in the main switching means.

11. A switching-mode power supply, including: an input section with first and second terminals, connected with a voltage source; overcurrent blocking means connected in series with one of the first and second terminals in a stage after the input section; a filter circuit connected between a series circuit and the second terminal of the input section, the series circuit consisting of the first terminal of the input section and the overcurrent blocking means; a transformer with primary and secondary windings, for transmitting, as an alternating current voltage, a voltage applied on the primary winding to the secondary winding; main switching means to be switched between a state where a voltage is applied on the primary winding and a state where the voltage is transmitted as an alternating current voltage to the secondary winding; and output means for rectifying and smoothing the alternating current voltage so as to output a direct current voltage,
said switching-mode power supply comprising:
detecting means for detecting a half short-circuit in the main switching means; and
filter short-circuit switch means, connected in parallel with the fitter circuit, which is capable of being conductive so as to cause a short-circuit between two output terminals of the filter circuit,
the detecting means causing the filter short-circuit switch means to be conductive when the detecting means detects a half short-circuit in the main switching means.

12. The switching-mode power supply as set forth in claim 11, further comprising current supply blocking switch means, connected in series with the main switching means, which is capable of being nonconductive so as to block supply of a current to the main switching means,
the detecting means causing the current supply blocking switch means to be nonconductive when the detecting means detects a half short-circuit in the main switching means.

13. The switching-mode power supply as set forth in claim 11, further comprising main switching element short-circuit switch means, connected in parallel with the main switching means, which is capable of being conductive so as to cause a short-circuit between two power supply lines connected with the primary winding,
the detecting means causing the main switching element short-circuit switch means to be conductive when the detecting means detects a half short-circuit in the main switching means.

14. The switching-mode power supply as set forth in claim 11, further comprising capacitor short-circuit switch means capable of being conductive so as to cause a short-circuit between both ends of an input smoothing capacitor for smoothing a voltage to be applied on the primary winding,
the detecting means causing the capacitor short-circuit switch means to be conductive when the detecting means detects a half short-circuit in the main switching means.

15. The switching-mode power supply as set forth in claim 11, wherein the detecting means detects a half short-circuit in the main switching means by detecting that a voltage smoothed by an input smoothing capacitor for smoothing a voltage to be applied on the primary winding has a predetermined variation width or more.

16. The switching-mode power supply as set forth in claim 11, wherein the detecting means detects a half short-circuit in the main switching means by detecting that a current of a predetermined amount or more flows in an input smoothing capacitor for smoothing a voltage to be applied on the primary winding.

17. The switching-mode power supply as set forth in claim 11, wherein the detecting means detects a half short-circuit in the main switching means by detecting that rectifying means has a predetermined temperature or more, the rectifying means being provided for rectifying an input alternating current voltage in a stage before an input smoothing capacitor for smoothing a voltage to be applied on the primary winding.

18. The switching-mode power supply as set forth in claim 12, further comprising capacitor short-circuit switch means capable of being conductive so as to cause a short-circuit between both ends of an input smoothing capacitor for smoothing a voltage to be applied on the primary winding,
the detecting means causing the capacitor short-circuit switch means to be conductive when the detecting means detects a half short-circuit in the main switching means.

19. The switching-mode power supply as set forth in claim 13, further comprising capacitor short-circuit switch means capable of being conductive so as to cause a short-circuit between both ends of an input smoothing capacitor for smoothing a voltage to be applied on the primary winding,
the detecting means causing the capacitor short-circuit switch means to be conductive when the detecting means detects a half short-circuit in the main switching means.
